(19) United States
(12) Patent Application Publication
(10) Pub. No.: US 2006/0031079 A1
(43) Pub. Date: Feb. 9, 2006

(54) College and employment integration system

(76) Inventor: Jay Motz, Austin, TX (US)

Correspondence Address: JAY MOTZ, 2 COVE CREEK LANE, AUSTIN, TX, 78738, US

(21) Appl. No.: 10/911,460

(22) Filed: Aug. 4, 2004

(51) Int. Cl. G06Q 99/00

(52) U.S. Cl. 705/1; 705/80

(57) ABSTRACT

Described herein is a method to converge college education with employment to produce a high quality labor pool of $0 per hour workers who are geographically located in the United States, by having businesses offer an 8 year Education-Employment contract consisting of a 4 year Bachelor degree, a 2 year Master degree, and 2 years of employment at a management and\or technical job, with the terms of said employment being negotiated and contractually guaranteed at the time of Freshman enrollment.

### BACKGROUND OF THE INVENTION

Businesses have historically deferred to universities and professors for the award of Bachelor and Master degrees, even though many businesses have sophisticated in-house training programs that are designed to take entry level employees and groom them for management and\or technical positions; hence there is no academic or intellectual reason why businesses can not award 4 year Bachelor and 2 year Master degrees independent of universities and professors. Detailed herein are systems and methods to create a seamlessly integrated 8 year Education-Employment contract signed by a student and a sponsoring business at the time of Freshman enrollment, that includes a 4 year Bachelor degree at $0 tuition, 2 year Master degree at $0 tuition, and 2 years of employment upon Master degree graduation; with said Education-Employment contract allowing a business to replace the traditional university campus with the facilities and employees of said business, and to gain 6 years of $0 per hour labor from college students in exchange for on the job management and\or technical training at said business facilities, with said Education-Employment contract benefiting students by eliminating tuition costs and allowing each student to contractually secure at the time of Freshman enrollment 2 years of employment at a good paying management and\or technical job with said sponsoring business upon graduation (years 7-8 of the Education-Employment contract).

### SUMMARY OF THE INVENTION

The ‘Student Equity Entrepreneur Development’ (herein ‘SEED’) technology creates a seamlessly integrated 8 year Education-Employment contract that is offered to Freshman applicants by a business in a field that reflects the activities of the business. For example, a hotel company will offer Bachelor-Master degrees in Hotel Administration; a computer manufacturer will offer Bachelor-Master degrees in Computer Science; a finance company will offer Bachelor-Master degrees in Finance and\or Banking; and so on for the full spectrum of management and technical jobs of those businesses that comprise the fabric of American industry, with each business grooming its college students for the high paying management and\or technical jobs that college students covet.

The first 6 years of the Education-Employment contract requires students to earn their Bachelor-Master degrees by working full time at $0 per hour for their sponsoring business, and the last 2 years of the Education-Employment contract requires the business to hire said student at the management and\or technical job specified at the time of Freshman enrollment, thus the Education-Employment contract allows each Freshmen college applicant to contractually secure a high paying management and\or technical job prior to investing 6 years of their labor to earn Bachelor and Master degrees.

The SEED technology replaces the traditional university campus with the facilities of each sponsoring business, which costs each sponsoring business $0 because each SEED college student plays the role of an ‘ordinary’ employee who is being groomed by the business for a management and\or technical job in years 7-8 of the Education-Employment contract, and as such the cost of a SEED college education is $0 and sponsoring businesses may charge $0 tuition to each student who signs an ≈8 year Education-Employment contract.

The SEED technology allows CEOs and employees of businesses to award Bachelor and Master degrees, and to provide 100% of the education of Bachelor and Master degree students by full time work in corporate sponsored management and\or technical training programs, thereby converging college education with employment and allowing businesses to utilize the ≈9,600 hours of $0 per hour labor that college students are willing to invest to earn their Bachelor and Master degrees.

### LIST OF FIGURES

FIG. 1, ‘8 Year Education-Employment Contract Diagram’

### DETAILED DESCRIPTION OF THE INVENTION

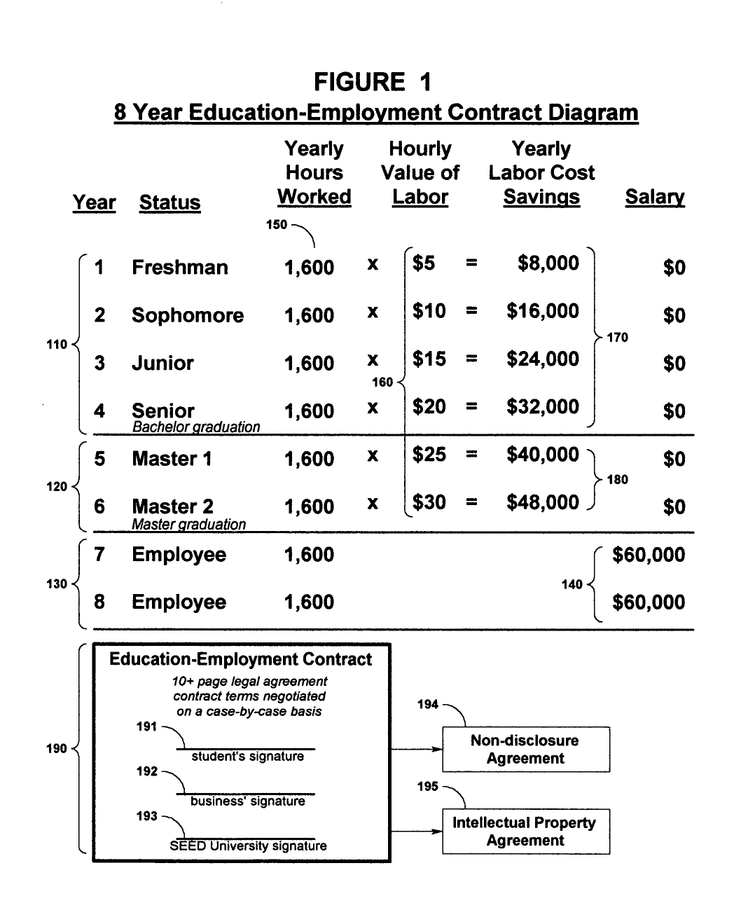

A business (or any entity that has good paying management and\or technical jobs to offer to Master level college graduates) interviews and selects high school graduates for entrance into the company's 8 year management and\or technical training program, which includes an 8 year Education-Employment contract (FIG. 1) consisting of a 4 year Bachelor degree during years 1-4 110, and a 2 year Master degree during years 5-6 120, and a 2 year Employment contract during years 7-8 130 (negotiated and signed by a student and a business at the time of Freshman enrollment 190) that allows applying Freshmen students to contractually secure a good paying management and\or technical job with said business upon completing their Master degree program 140.

Obtaining a good paying job after graduation is the primary reason why many young people attend college. While the definition of what a good paying job is varies with individual perception and different costs of living from city to city; for the purpose of this Patent it is held that Master level college graduates do not covet jobs that pay less than ≈$60,000 per year, and increasingly covet jobs that pay more than ≈$60,000 per year; hence a primary goal of most Master level college graduates is to obtain a ≈$60,000+ per year job after graduation, with it noted that such jobs are scarce in today's 21^{st} century economy.

This Patent uses an 8 year Education-Employment contract as a best mode, with it noted that the Education and Employment elements can be shortened to create a ≈5 year Education-Employment contract consisting of a 4 year Bachelor degree and ≈1+ year Employment contract, or lengthened to create an ≈11 year Education-Employment contract consisting of a 4 year Bachelor degree, 2 year Master degree, ≈2 year Ph.D. and ≈3+ year Employment contract, or otherwise modified to accommodate the industry standard college degrees of Associate, Bachelor, Master and Ph.D.

With the 8 year Education-Employment contract a business will gain 6 years of high quality $0 per hour labor from each college student, with full time employment being defined as 1,600 hours per year 150 (40 hours per week times 50 weeks per year: net of sick leave, holidays and vacation time), thus in 6 years a college student will provide their sponsoring business with 9,600 hours of $0 per hour labor.

The hourly financial value of the student labor to a business will increase each year as novice Freshman, Sophomore and Junior level students learn skills and mature to seasoned employees. With prevailing 2004 U.S. labor rates, for the purpose of this Patent it is held that Freshman students will perform work valued at $5 per hour 160, Sophomores $10 per hour, Juniors $15 per hour, Seniors $20 per hour, Master-1 $25 per hour and Master-2 $30 per hour. (To facilitate comprehension all financial numbers are stated in 2004 U.S. dollars, with a 0% inflation rate for years 0 through 8; with it understood that the Education-Employment contract is designed to be indexed to future inflation rates.)

As college students progress from Freshmen through the Master level they will perform increasingly valuable tasks for the business they work for, such that entry level 4 year Bachelor students will save their sponsoring business ≈$80,000 in labor costs 170, and the more highly skilled 2 year Master students will save their sponsoring business an additional &$86,000 in labor costs 180; such that in 6 years a typical Bachelor-Master student will provide their sponsoring business with ≈9,600 free labor hours that will save their sponsoring business ≈$168,000 in labor costs relative to if the same labor had been performed by salaried workers.

Businesses must pay at least the Federal minimum wage to each employee, hence today's universities are precluded by the Federal minimum wage law from having their college students work for $0 per hour for profit oriented businesses. With the SEED format each student signs a seamlessly integrated 8 year Education-Employment contract, such that they agree to work for a sponsoring business ≈1,600 hours per year for 8 years (≈12,800 hours), and will be paid a total of ≈$120,000 in salary (2 years guaranteed employment at ≈$60,000 per year in years 7-8); hence the average wage each student will be paid is ≈$9 per hour, which is well above the Federal minimum wage. With the Education-Employment contract college students can work for 6 years at $0 per hour and still meet the Federal minimum wage requirement, which is something that can not be done with today's segmented Bachelor and Master degree programs, which are not contractually linked to a guaranteed job upon graduation.

As a technical accounting matter, with an 8 year contract and an average annual inflation rate of ≈5%, the purchasing power of a salary will lose ≈25% of its value between the time of Freshman enrollment and the award of a Master degree 6 years latter, hence the Education-Employment contract can either be indexed to inflation or the sponsoring business can guarantee a salary at the time of Freshman enrollment that is based on an inflation estimate.

Millions of college students invest 6 years and pay ≈$50,000+ tuition (net of room and board) in order to learn skills and earn Bachelor-Master degrees that will enable them to obtain ≈$60,000+ per year jobs when they graduate; however with today's traditional university education there is no contractual linkage between the 4 year Bachelor degree, the 2 year Master degree, and a ≈$60,000+ per year Employment contract upon graduation.

Unlike traditional universities, the signing of each Education-Employment contract (191, 192, 193) at the time of Freshman enrollment is contingent upon guaranteed employment at the time of Master graduation. The 8 year Education-Employment contract is designed to target high paying ≈$60,000+ per year jobs on a one-to-one basis, with each sponsoring business being required to contractually agree at the time of Freshman enrollment that it will allocate one of its high paying management and\or technical jobs to a specific student upon Master graduation.

A typical mid sized company has a plurality of ≈$60,000+ per year jobs to fill each year, and will offer Education-Employment contracts to a plurality of SEED college students, thus each business that embraces the SEED technology will develop a portfolio of SEED college students. For example, a large hotel company may estimate that in 7 years it will have 100 new ≈$60,000+ per year jobs for hotel managers, and instead of offering these jobs to ‘off the street’ applicants, the hotel business may choose to reserve the 100 high paying jobs for

SEED college students (which will save the hotel company ≈$16,800,000 in labor costs during the next 6 years). With the SEED format the hotel company will interview each SEED student prior to accepting them for Freshman enrollment to see if they have the potential to be good hotel managers, and as the 100 students go through their Bachelor-Master training program the hotel company will expect a bell curve of below average, average and above average performance from the pool of SEED students; whereupon following graduation all 100 of the SEED graduates will be paid their contractually guaranteed #$60,000+per year salaries for 2 years, with the hotel company assigning the average performers to be managers of small hotels, and the above average performers to be managers of large hotels, and the below average performers to be assistant managers or to be employed in other capacities for the duration of their Education-Employment contracts.

With the SEED format an ≈18 year old high school graduate is not mature enough or qualified enough to compete with job applicants for today's ≈$60,000+per year management and\or technical jobs; but if they are accepted today into a company's ≈6 year SEED Bachelor-Master degree program then through ≈6 years of on the job training they will be expected to be able to compete for a ≈$60,000+ per year management job when they graduate with their Master degree. With today's legally segmented Bachelor degree, Master degree and employment system, college students do not apply for full time jobs until after they are awarded their Master degrees. With the SEED format each Freshman applicant is able to apply for a ≈$60,000+ per year management and\or technical job 6 years prior to being mature enough and qualified enough to fill the position.

A significant financial difference between a traditional college student and a SEED college student is: the traditional college student does not work and does not produce wealth for a specific business while they are in college, while each SEED student learns by working and producing wealth for a specific business, which makes each SEED student ≈$168,000 more valuable to a business than regular college students (or ‘off the street’ job applicants). With the SEED format it is reasonable for a business to offer 2 years of ≈$60,000+ per year employment in years 7-8, if the business knows it will receive ≈$168,000 worth of $0 per hour labor during years 1-6.

With the advent of the 8 year Education-Employment contract each business will identify its low paying jobs as being work students can perform as a requisite to earn their Bachelor and Master degrees (thus saving a business ≈$168,000 in labor costs); and each business will identify and recognize its high paying management and\or technical jobs (≈$60,000+ per year) as being an incentive that can be used to induce students to enroll into their corporate Bachelor and Master degree training programs.

With the SEED format chemical companies will offer Bachelor and Master degrees in Chemistry; aerospace companies will offer Bachelor and Master degrees in Aerospace Engineering; computer companies will offer Bachelor and Master degrees in Computer Science; hotel companies will offer Bachelor and Master degrees in Hotel Administration; and so on for the full spectrum of businesses that need to groom college students for management and technical jobs.

The SEED technology raises a foundational educational question, which is: ‘Who is better qualified to teach Bachelor and Master level college students: Ph.D. professors (theorists) or the CEOs and employees of America's businesses?’ The foundation of the SEED technology is the recognition that in a plurality of employment areas, the CEOs and employees of businesses are in a better position to offer high quality college education to America's youth through 6 years of on the job management and\or technical training programs, than are professors and universities. Businesses operate steel mills, chemical plants, automobile factories, aerospace assembly plants, computer chip making plants and office buildings filled with the full spectrum of financial, scientific, advertising and technical businesses; and the best place for college students to learn the skills required of these businesses is through on the job management and\or technical training, but today's college students are denied this learning opportunity because universities separate a traditional college education from full time employment.

The professional orientation of Ph.D. professors is to engage in ‘theory’, experimentation, classroom teaching and to publish articles; hence, there is little correlation between the professional goals of university professors and the job training and employment needs of America's businesses, and this is why virtually all students graduate from college and must then be trained ‘from scratch’ to perform specific jobs by the businesses that employ them.

A structural weakness of today's colleges is they are not engaged with manufacturing automobiles, running steel mills, managing hotels and manufacturing computers; hence universities and professors are detached from the practical job experience that is the pre-condition to fully understand and to most efficiently teach young people how to perform these management and\or technical employment tasks.

Another structural weakness of traditional universities, particularly in scientific and technical fields, is businesses hold large amounts of knowledge as closely guarded proprietary information that is only made available to employees who sign employment contracts that contain non-disclosure agreements; hence all college students in traditional universities are legally precluded from being exposed to and learning about important business and technical-scientific knowledge that America's businesses rely upon, because universities and their professors are legally prohibited from being exposed to and learning about said proprietary knowledge.

With the SEED Education-Employment contract 190 each sponsoring business can add a non-disclosure clause 194 to the contract so SEED students are legally prohibited from disclosing proprietary business and technical-scientific information to 3^{rd} parties, and the inclusion of this non-disclosure clause to the Education-Employment contract will allow each sponsoring business to expose its students to said proprietary and technical-scientific business information (an intellectual property clause 195 may also be added so any discoveries and\or inventions of a student shall be the property of said business).

From the perspective of the vested interests of American businesses, with legal protection by appropriate non-disclosure agreements, it is advantageous to expose ≈18 to ≈24 year old ‘youngsters’ to said proprietary business and technical-scientific knowledge because the uninhibited and creative minds of this age group has proven itself to be a major source of innovation. The SEED technology is designed to allow businesses in scientifically competitive industries to immerse ≈18 to ≈24 year old students into the most intimate proprietary knowledge of said businesses during the Education portion of their Education-Employment contract, with the expectation that this will quicken innovation and thereby enhance the competitiveness of businesses that embrace the SEED technology.

With the SEED format each Bachelor student earns their Bachelor degree by working full time for 4 years (6,400 hours) and earns their Master degree by working full time for 2 years (3,200 hours); and there are no required classes to take or academic tests because with the SEED educational and accreditation standards the full time work performed at each company's employment standards are deemed to be sufficient to award Bachelor and Master degrees; with each sponsoring business being motivated to teach each SEED student as much relevant knowledge as possible because each student is being groomed for a ≈$60,000+ per year management and\or technical job in which they (on average) will be responsible for ≈$300,000+ per year in gross sales of their sponsoring business and millions of dollars worth of corporate assets.

As each SEED student progresses from a Freshman to a Sophomore to a Junior to a Senior and then Master level student, the employees of the student's sponsoring business will evaluate the student's job performance and advance them in accordance with their abilities. At the end of the Education portion of each SEED student's Education-Employment contract, each student will have a Bachelor degree and a Master degree in their area of expertise, and a resume that lists their job accomplishments during the previous 6 years, plus whatever Federal, State, Local and professional licensing exams and certificates the student passed and acquired during the previous 6 years. Instead of graduating with a traditional college transcript with A-B-C-D-F grades received in ≈60 university classes; SEED student's will graduate with extensive resumes covering their 6 years of full time work while in college, and with a 2 year, ≈$60,000+ per year employment contract to start them on their careers with a good paying management and\or technical job.

To ensure the overall quality of the SEED technology and of each Education-Employment contract, in a best mode there will be established a national non-profit organization here-in called ‘SEED University’, whose staff shall be responsible for setting standards and approving each business and each student that wishes to participate in the SEED education-employment program; hence both businesses and college students will need to apply to SEED University if they wish to utilize the SEED technology; with all Associate, Bachelor, Master and Ph.D. degrees being issued by SEED University in conjunction with the sponsoring business of each SEED college student (as per the terms of their Education-Employment contract 193).

The merit of each SEED University degree will primarily be a function of (a) the overall reputation of SEED University and the quality of its students, and (b) the reputation of the sponsoring businesses affiliated with SEED University. In a best mode it is to the mutual advantage of the plurality of SEED college students and plurality of sponsoring businesses to have an independent 3^{rd} party (such as SEED University) to act as an overall coordinator of the SEED technology; such that SEED University shall endeavor to enhance its reputation and the merit of SEED University's Associate, Bachelor, Master and Ph.D. degrees by associating itself with ‘name brand’ sponsoring businesses that have good reputations, and by negotiating and setting minimum standards for the key elements of all of the Education-Employment contracts.

SEED University will act as an umbrella organization and each college that comprises SEED University will be led by businesses that have expertise in their field. For example, internal to SEED University may be the Marriott® College of Hotel Administration, and the Boeing® College of Aerospace Engineering, and the DELL® College of Computer Science, and the ExxonMobile® College of Petroleum Engineering; and so on for the full spectrum of colleges that are required to train young people for the management and\or technical jobs of the sponsoring businesses; thus the overall reputation of SEED University will be a function of the reputations of the businesses that SEED University is able to bring under its umbrella, with the idea being that name brand companies like Marriott®, Boeing®, DELL®, and ExxonMobile® have reputations that are comparable in quality to Harvard®, Yale®, Cornell® and Stanford®.

Traditional universities have just one college per academic category, whereas SEED University will endeavor to have a plurality of sponsoring businesses in each academic category, thus making the SEED format available to all competing businesses that wish to embrace the SEED format. For example, in a best mode in the field of computer science SEED University may have the DELL® College of Computer Science (Austin, Tex.), the Microsoft® College of Computer Science (Seattle, Wash.), the Apple® College of Computer Science (Palo Alto, Calif.), and the IBM® College of Computer Science (Southbury, Conn.); with each company being responsible for establishing the quality and reputation of their SEED University Bachelor-Master-Employment program, and with each company reviewing the applications of Freshman applicants and competing on a national basis to recruit the best applicants into their company's SEED University College program.

With the SEED format the corporate facilities and employees of each sponsoring business become the SEED University campus. At no capital cost to each sponsoring business (and at a labor cost savings to each sponsoring business of #$168,000 per SEED student), and at no capital cost to SEED University; SEED University can establish a national, geographically dispersed, university campus consisting of the most sophisticated business facilities in America that are worth hundreds of billions of dollars, and whose salaried employees possess a vast reservoir of state-of-the-art proprietary knowledge that is today geographically and legally ‘off limits’ to all traditional university students.

With the SEED format large businesses will have the status and reputations of the Ivy League universities, and in addition SEED University will enable smaller businesses with less well known reputations (equivalent to small private colleges) to participate in the SEED technology by offering their Education-Employment contracts under the SEED University umbrella. For example, a 50 room hotel in Maine (called ‘Ocean Hotel’) may only need one SEED student-employee, hence by affiliating with SEED University the hotel can offer a Bachelor and Master degree in Hotel Administration with the degree being issued by SEED University in association with Ocean Hotel's College of Hotel Administration (with the 50 room hotel and employees serving as the local campus of SEED University).

In each SEED University college a wide spectrum of large and small businesses can participate in the SEED technology, with each sponsoring business being able to control the quality, reputation and content of its SEED Associate, Bachelor, Master and Ph.D. degree training programs, and with total national enrollment into SEED University being a function of how many good paying management and\or technical jobs America's businesses are willing to contractually guarantee.

Separate from and paralleling today's college accreditation procedures and standards, SEED University and its affiliated sponsoring businesses will establish accreditation procedures and standards to enhance the merit of the Associate, Bachelor, Master and Ph.D. degrees awarded by SEED University; with the primary difference being that instead of Ph.D. professors establishing the accreditation procedures and standards, the CEOs and employees of America's businesses will establish the accreditation procedures and standards.

With the SEED format ≈100% of the costs of a traditional college education (except for room and board) are eliminated because the traditional university campus is eliminated and is replaced with the facilities of each sponsoring business, and each SEED student is simply another employee of a business (who is being groomed over the course of ≈6 years for a ≈$60,000+ per year management and\or technical job); and as such there is no need for businesses that embrace the SEED technology to charge any tuition to college students; thus, with the SEED technology college tuition is eliminated and college students accepted into SEED University will not have to pay tuition, apply for student loans, or graduate with student loan debts.

What I claim as my invention is:

1. A method whereby an 8 year Education-Employment contract consisting of a 4 year Bachelor degree (during years 14), and a 2 year Master degree (during years 5-6), and a 2 year Employment contract (during years 7-8), signed by a student and a business, allows an applying Freshman student to negotiate and contractually secure at the time of Freshman enrollment a management and\or technical job with said business upon completing their Master degree program.
1a. claim 1 wherein the 8 year Education-Employment contract is shortened to a ≈3 year Education-Employment contract consisting of a 2 year Associate degree (during years 1-2) and a ≈1 year Employment contract (during year ≈3); or is lengthened to an ≈11 year Education-Employment contract consisting of a 4 year Bachelor degree (during years 1-4), and a 2 year Master degree (during years 5-6), and a 2 year Ph.D. (during years 7-8), and a ≈3 year Employment contract (during years 9-11); or whereby said Education-Employment contract is otherwise modified on a case-by-case basis to accommodate the well known Associate, Bachelor, Master and Ph.D. degree programs with a suitable duration and salary value of Employment upon graduation.
1b. claim 1 whereby an 8 year Education-Employment contract allows a business to meet Federal and State minimum wage requirements by paying enough salary in years 7-8 to exceed the minimum wage for the total work hours of said Education-Employment contract (years 1-8), and thereby provide a business based in the United States with a method to reduce their labor costs (during years 1-6) to $0 per hour per worker, by having $0 per hour student-workers perform tasks that salaried employees ordinarily perform.
1c. claim 1 whereby 100% of the costs of a traditional university education (not including room and board) are eliminated by utilizing the assets, facilities and employees of a business as a college campus, with each business educating college students through 6 years of on the job training, there-by enabling a business to charge $0 tuition to each Bachelor and Master degree student, thus making the cost of college education $0 to students.

2. A method to upgrade the employment relevancy of Bachelor and Master level college education by shifting college instruction from university campuses to business facilities, such that Associate, Bachelor, Master and Ph.D. level students earn their degrees by working for businesses in management and\or technical job training programs instead of by sifting in classrooms and reading books; whereupon 2 years of satisfactory full time work is deemed to be sufficient to award an Associate degree, and an additional 2 years of satisfactory full time work is deemed to be sufficient to award a Bachelor degree, and an additional 2 years of satisfactory full time work is deemed sufficient to award a Master degree, and an additional 2 years of satisfactory full time work is deemed sufficient to award a Ph.D.; with said degrees being awarded by the business associated with each Education-Employment contract (or by a university affiliated with said Education-Employment contract).

3. A method to enhance the quality and job relevancy of college education in most business, technical and scientific fields, by exposing college students to the vast reservoir of intellectual property and proprietary information held by America's businesses and other entities, by including a non-disclosure clause in said Education-Employment contract (claim 1) signed by a student and a business upon Freshman enrollment such that the intellectual property and proprietary information of said business is legally protected and can be disclosed to said student on a contractual basis; and wherein said non-disclosure clause is augmented with an intellectual property clause such that any ideas and innovations invented or discovered by a student shall be the property of the business that signed said Education-Employment contract with said student.

4. A method whereby the standards and practices of traditional universities and professors for awarding Associate, Bachelor, Master and Ph.D. degrees are replaced by a parallel set of standards and practices that are established by the CEOs and employees of businesses that offer Associate, Bachelor, Master and Ph.D. level management and\or technical training programs, such that a specified number of years of satisfactory work for a business in a management and\or technical training program is deemed to be sufficient for the business (or an affiliated university) to award a student an Associate, Bachelor, Master or Ph.D. degree.
